(19) United States
(12) Patent Application Publication
(10) Pub. No.: US 2007/0089832 A1
(43) Pub. Date: Apr. 26, 2007

(54) Repositionable matte photo media

(76) Inventors: Jonathan P. Kitchin, Leander, TX (US); Dwight L. Evans, Cedar Park, TX (US); Constance J. Nelson, Stillwater, MN (US)

Correspondence Address: 3M INNOVATIVE PROPERTIES COMPANY, PO BOX 33427, ST. PAUL, MN, 55133-3427, US

(21) Appl. No.: 11/227,604

(22) Filed: Sep. 15, 2005

(51) Int. Cl. B32B 37/00

(52) U.S. Cl. 156/289; 40/594; 40/760

(57) ABSTRACT

The present invention provides a matte repositionable photo media has an imageable substrate having opposing first and second surfaces. An image receptive coating is disposed on the first surface of the inkjet printable sheet. A repositionable adhesive is disposed on the second surface of the substrate, but the adhesive does not cover the entire second surface. A liner is disposed on the second surface of the substrate. The photo media has a gloss value at 600 of 25% or less, an adhesion to polyester of 200 gram/inch or less and a static angle test adhesion value of greater than 600 seconds.

### CROSS REFERENCE TO RELATED APPLICATION

The present application is related to US Patent Application having an attorney docket number 61232US002, filed on even date herewith.

### FIELD OF INVENTION

The present invention pertains to a repositionable photo media that is particularly suited for use with digital photography. In particular, the present invention pertains to a matte photo media that can be readily imaged using a digital printer to create photographs that can be adhesively attached to a substrate for display and viewing.

### BACKGROUND

The use of digital cameras has increased in recent years. For example, in digital photography, the consumer can capture the desired images using the digital camera, view the images (now pictures) almost instantaneously on the camera screen, and at a later time select which image, if any, should be printed on photo media for display and viewing. Thus with digital photography, the photographer has the ability to select the most desirable images from a repertoire of stored images. In contrast, in traditional photography, most consumers take photos of the intended image, which is captured on the camera film. The exposed film is taken to a photo-processing lab, which in turn generates a hard copy of the photographs. Because there is no ability to preview the photos, the consumer would receive all the pictures and consequently pay for all the pictures, whether the picture turned out as intended or not.

There are a whole host of commercially available digital camera manufacturers, such as Hewlett Packard, Sony Corporation, and Nikon Corporation, to name a few. One advantage of digital images is that they can be saved and stored in the camera's processor and later sent to a digital printer to generate a hard copy of the image for display, archiving, scrapbooking, and similar activities. Like the digital cameras, there are many commercially available photo papers that a consumer can use to generate a hard copy of the image. Hewlett Packard, e.g., offers a variety of matte, semi-gloss, or glossy photo paper. Some of these photo papers can be used for archival purposes, if desired. None of these photo papers contain a means for adhesively, repositionably attaching the photo to a desired substrate.

The company AERO Komerciala, Celje, Slovenija, whose website as of the filing date of this application is www.aero.si, offers a Tix® Tape Mega Memo, which has been described in Aero's product literature as an A4 size paper (about 21 cm by 30 cm) having a removable adhesive stripes coated applied along the shorter edges, protected with two siliconized liner strips, each about 4 cm wide by 21 cm long. One disadvantage of having such a construction is that upon stacking the paper in a paper tray of the printer, because of the two liners at the edges, the paper will stack with uneven thickness, i.e. higher at the ends than in the middle of the stack. This uneven thickness in stacking may result in poor paper feed reliability as the paper travels through the printer.

One disadvantage of a fully adhesive coated paper is that upon removal of the paper from the display surface, the paper and the photo imaged thereon may be destroyed because the paper curls and creases. Furthermore, removal of a fully backed adhesive paper on a substrate can be difficult, because like a piece of tape or a label, one must start peeling from an edge or a corner of the paper to begin lifting it off the substrate.

With the availability of digital cameras and with the advent of various digital printers, on demand printing has become more commonplace behavior. There are consumers who prefer the ability to print the digital photos at their leisure and the photos may not be archived after display. There is a need for quality, lower cost, photo media. There is also a need for photo media that is not fully coated with adhesive for ease of liner removal and ease of media removal and or repositioning on a substrate without damaging the photo.

### SUMMARY

The present invention relates to a photo media that is intended as a consumable product. The photo media includes a base sheet, a repositionable adhesive, and a liner to allow for easy one-step, print to display of the image. With the infrastructure available for creating, electronically saving, and printing digital photos, the inventive photo media is especially useful for generating the digital photos. Once done with displaying the photo, the consumer can but does not need to archive the photo. In this way, photos can be updated on a regular basis and the photos can be displayed quickly without the need to use a frame or alternative hardware used to display photos. Photos can also be displayed on any horizontal or vertical surface that the repositionable adhesive can be adhered to, such as, e.g., refrigerators (without the need for using magnets), wood or plastic surfaces (without the need for using additional tape), fabrics, walls, and windows. The repositionable adhesive is selected to provide good adhesion to the intended surface and yet not leave residue adhesive once the photo media has been removed. Advantageously, the inventive photo media is of a lower cost than those that are intended for archival purposes and with the feature of ease of display, the consumer has immense flexibility in displaying the number of photos and in selecting the location for display.

In one aspect, the present invention pertains to a repositionable matte photo media comprising: (1) an imageable substrate comprising a base sheet having opposing first and second surfaces and an image receptive coating disposed on the first surface of the base sheet; wherein the imageable substrate has a gloss value at 60° angle of about 25% or less; (2) a repositionable adhesive disposed on the second surface of the base sheet, wherein the adhesive does not cover the entire second surface; and (3) a liner disposed on the repositionable adhesive, wherein the photo media has an adhesion to polyester of less than about 200 gram/inch and a static angle testing adhesion value of greater than about 600 seconds.

In another aspect, the present invention pertains to a method of making a matte repositionable photo media comprising the steps of: (1) providing a base sheet having opposing first and second surfaces; (2) coating an image receptive coating on the first surface of the base sheet; (3) drying the image receptive coating to yield an imageable substrate having a gloss value at 60° angle of 25% or less; (4) coating a repositionable adhesive on the second surface of the base sheet, wherein the adhesive does not cover the entire second surface; and (5) laminating a liner to the second surface of the base sheet so as to cover the repositionable adhesive, wherein the photo media has an adhesion to polyester of less than about 200 gram/inch and a static angle testing adhesion value of greater than about 600 second.

In yet another aspect, the imageable substrate has a gloss value of about 15% or less. In yet another embodiment, the imageable substrate has a gloss value of about 10% or less. All gloss values are measured at 60° angle, using a gloss meter, such as a Micro Gloss Meter, available from BYK-Gardner USA, Columbia, Md.

In use, once the consumer selects an image for display, he/she would use the process for creating the digital photo and input the inventive photo media in the printer tray that holds the photo media. After the image is printed on the photo media, the consumer can remove the liner and then attach the photo to a desired surface for display.

In this document, the term “about” is presumed to modify all numerical values.

### BRIEF DESCRIPTION OF THE DRAWING

The invention can be better described with reference to the following drawing, wherein

FIG. 1 is a schematic cross-sectional view of one embodiment of the present invention; and

FIG. 2 is a view of a backside of another embodiment of the present invention.

These figures are idealized, are not drawn to scale, and are intended for illustrative purposes only.

### DETAILED DESCRIPTION

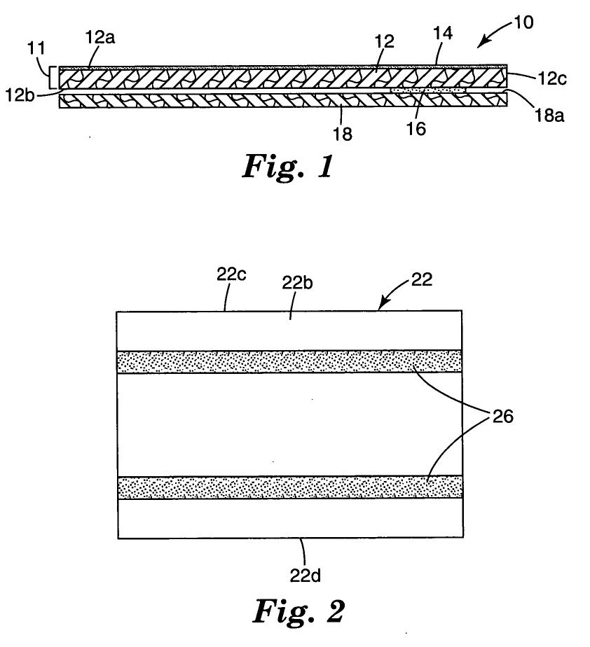

FIG. 1 shows a cross-sectional view of photo media 10. The photo media includes imageable substrate 11 having base sheet 12 and image receptive coating 14. The base sheet has opposing first surface 12a and second surface 12b. The image receptive coating is disposed on and covers substantially the entire first surface of the base sheet. Repositionable adhesive 16 is disposed on the second surface of the base sheet and does not cover the entire surface area of the second surface. Liner 18 is substantially the same size as the base sheet; the liner is disposed on the adhesive and substantially covers the entire second surface of the base sheet. In one embodiment, the liner includes a release coating disposed on major surface 18a so that the release coating is in direct contact with the repositionable adhesive. If desired, the opposing surface of surface 18a may be printed with indicia. While the repositionable adhesive can be placed anywhere on the second side of the base sheet, in one embodiment, the adhesive is in the form of at least one stripe that is offset from and substantially parallel to edge 12c. In another embodiment, repositionable adhesive is disposed on the base sheet such that the leading edge of the sheet, as it enters a printer having a primary feed wheel, is adhesively attached to the liner at the point the primary feed wheel contacts the sheet.

FIG. 2 is a view of the backside of a photo media showing second surface 22b of base sheet 22, the base sheet having two opposing substantially parallel edges 22c and 22d. Offset from the edges are two substantially parallel repositionable adhesive stripes 26. Other stripe configurations and different number of stripes can be used. For example, in an 8½ by 11 inch format, the photo media typically includes more than two stripes, usually four to five stripes, of adhesive. The adhesive can also be disposed immediately next to the edge, if desired. Instead of using stripes of adhesive, other patterns can be used, such as islands of adhesives, so long as the adhesive does not cover the entire surface area of the second surface of the base sheet. In non-stripe form, the adhesive can be disposed on the second surface so as to leave at least one edge of the photo media free of adhesive. Such a construction allows for easy removal of the liner before attaching to a surface and easy removal of the photo media after it has been applied to the display surface. The amount of surface area of the second surface that needs to be covered with the adhesive depends upon, among other factors, the size of the photo media, the repositionable adhesive used, and the intended display mode and location of the photo media.

The base sheet can be constructed from a variety of materials including, e.g., paper, plastic (including foams and non-wovens), and textiles (wovens). The term “plastic” generally means thermoplastic or thermoset polymers that can be made into films or sheets. The term “textiles” generally mean woven materials or fabrics of natural fibers, artificial fibers, or a combination thereof. In one embodiment, the base sheet has a basis weight of 180 gram/m² or less. In another embodiment, the base sheet has a basis weight of 150 gram/m² or less.

In one embodiment, the base sheet is less than 0.010 inch (0.25 mm) in thickness. In one embodiment, when paper is used, the paper is supplied in calendared form, and the image receptive coating is coated thereon. One suitable paper is 100# Text Lunar paper, commercially available from Domtar, Inc., Quebec, Canada. Other suitable paper includes those commercially available from Scholler and Hewlett Packard.

Suitable plastics would include, e.g., polyolefin, polyester, polystyrene, polyamide, polyurethane and copolymers thereof. These materials may optionally be compounded with white pigment, nanoparticles or vesicles to mimic the appearance of paper. Plastics further include single and multilayer film constructions of one or more polymer materials, including blends, composites, and copolymers. The plastic films may be chemically or mechanically (calendering, orienting) modified to mimic paper like performance with the added benefit of enhanced moisture and curl resistance, when compared to paper substrates.

The image receptive coating can be of any composition that adheres to the substrate and is suitable for digital printing, such as inkjet printing, color inkjet printing, laser printing, and dye or mass transfer printing. When the image receptive coating is an inkjet receptive coating, suitable coatings would include two general classes of compositions: (1) those that absorb ink by capillary action, commonly described as porous, microporous, or nanoporous coatings, which may include silica, mixed oxides, and hydroxides of aluminum, and (2) those that include a matting agent and a hydrophilic polymer that absorbs ink by swelling, which are commonly referred to as swellable polymer coatings.

Suitable porous, microporous, or nanoporous coatings include U.S. Pat. No. 6,502,935 (Barcock et al.) and U.S. Pat. No. 6,830,798 (Misuda et al.).

Suitable swellable polymer, ink receptive coatings are described in U.S. Pat. No. 5,134,198 (Stofko, Jr. et al.), and U.S. Pat. No. 5,389,723 (Iqbal et al.). In very brief summary, both patents describe semi-interpenetrating polymer networks. These networks are blends of polymers where at least one of the polymeric components is crosslinked after blending to form a continuous network throughout the bulk material, and through which the uncrosslinked polymeric components are intertwined in such a way as to form a macroscopically homogeneous composition. Another suitable image receptive coating is described in U.S. Pat. No. 6,806,310 (Kopolow et al.), which discloses copolymers of dimethylaminopropyl methacrylamide (DMAPMA) and hydroxyethyl methacrylate (HEMA). It is stated that substrates coated with these copolymers are capable of absorbing the solvents, e.g., water or organic solvents, of digital printing inks rapidly with dry times of less than one minute. Yet another suitable image receptive coating is described in US Patent Application Publication No. US 2005/0027068, which discloses terpolymer compositions of vinyl caprolactam, DMAPMA, and HEMA to coat substrates for use in computer printers. Suitable matting agents for use with the hydrophilic swellable polymer include (1) inorganic materials such as silica and calcium carbonate, or (2) organic polymers such as polyacrylates, polystyrene, polyesters, polyamides, urea formaldehyde resins or (3) naturally occurring materials such as starch. The particle size of the matting agent is preferably of the same order of magnitude as the wavelength of visible light from 0.1 to 1 micron.

As stated, a repositionable adhesive is disposed on the second surface of the base sheet and not on the entire surface area of the second surface. Various repositionable adhesives can be used. Suitable repositionable adhesives are disclosed in U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delagado); U.S. Pat. No. 5,073,457 (Blackwell) and U.S. Pat. No. 5,571,617 (Cooprider et al.), U.S. Pat. No. 5,663,241 (Takamatsu et al.); U.S. Pat. No. 5,714,237 (Cooprider et al.); US RE 37,563 (Cooprider et al.); and U.S. Pat. No. 5,756,625 (Crandall et al.) and U.S. Pat. No. 5,824,748 (Kesti et al.). The repositionable adhesive can be solvent based, water based, or can be a solventless, hot melt adhesive.

The photo media of the present invention can be further characterized by two adhesion tests: adhesion to polyester (specifically polyethylene terephthalate), and (2) static angle test (SAT). Both are described below in detail.

The adhesion to polyester test is performed by laminating a 1.25 inch (32 mm) strip of plain polyester, product designation OR16 film from 3M Company, St. Paul, Minn., over the previously coated and dried sample of repositionable adhesive. The polyester is laminated to the adhesive by using a 2 kg rubber coated roller rolling at a rate of 12 inch/min (25.4 mm/min). Using a stress/strain gauge, such as one available from Instron Corp., the polyester film is pulled away from the adhesive at a 90° angle at a peel rate of 12 inch/min (305 mm/min). The peel force is recorded in grams/inch.

The SAT measures the ability of the photo media with its repositionable pressure sensitive adhesive to remain adhered on a standard test panel while being subjected to removal pressure at a specified peel angle under a constant load. The static angle test is one quantitative procedure for measuring detachment resistance of the photo media.

In performing static angle test, six photo media samples can be prepared using the following exemplary process. The samples are all the same size, 33 mm wide by 76 mm long. Each sample of photo media includes an adhesive stripe that is 18 mm wide by 33 mm long, where the long dimension of each adhesive stripe is positioned along the short dimension of, and at the top of, each photo media sample.

The test panel is a steel panel with a painted surface. Each sample is applied to the painted steel panel with the long dimension of the adhesive stripe horizontally oriented and located at the top of the photo media sample. Then, the sample is pressure adhered to the painted steel surface by two passes of an application roller with an application pressure of 1.5 pounds per square inch (77.6 mm of mercury).

The mounted sample is placed in a holder frame that is vertically oriented approximately perpendicular to a ground surface. The painted steel panel is held at a 30° downward angle relative to the vertically oriented frame. A 100 gram load is applied to the lower end of the photo media sample, proximate to the lower end of the holder frame. A timer is started upon application of the 100 gram load to measure how long the sample remains attached to the painted steel surface before the photo media sample detaches from the steel panel. The SAT usually runs to failure, i.e., until the sample actually detaches form the steel panel. The time to detachment is usually measured in seconds as the average of six results.

The photo media of the present invention has an adhesion to polyester value of 200 gram/inch (7.9 gram/mm) or less, preferably less than 160 gram/inch (6.3 gram/mm) or less, and a SAT value of 600 seconds or greater, preferably 1800 seconds or greater. The lower the adhesion to polyester value, the easier it will be to remove the photo media from the substrate to which it has been attached. The higher the SAT value, the more likely the photo media will remain adhered to the intended substrate once it has been applied.

The liner is used to protect the repositionable adhesive until application. The liner can be any paper or plastic sheet that bonds to the repositionable adhesive securely during storage and while passing through the feed mechanism of a printer. The liner releases cleanly and easily from the repositionable adhesive after printing the photo paper. The liner may be treated with a release coating to achieve the desired release performance. Suitable coatings include those that based on straight chain alkane derivatives, polydialkyl siloxane derivatives, or fluorocarbon derivatives. One exemplary release coating is described in U.S. Pat. No. 5,032,460 (Kanter et al.). The release coating will be applied on the liner, typically the entire surface area of the liner, to reach a dry coating weight of from 0.05 gram/ft² (0.54 gram/m²) to 0.1 gram/ft² (1.1 gram/m²). Suitable silicone-based release liners are commercially available from Loparex, Inc., Willowbrook, Ill.

In one exemplary process, the inventive photo media is made in a continuous process as follows. The image receptive coating is coated on the first side of the base sheet using conventional coating techniques, such as gravure coating or die coating. The coated base sheet passes through a drying unit, such as an oven. At the next station, to the second side of the base, the repositionable adhesive is applied in a desired pattern using conventional coating methods. Optionally, an additional primer coating may be interposed between the adhesive and the base sheet. The adhesive coated base sheet, whether or not primed, passes through a second drying unit. A liner is then laminated to the base sheet such that the liner contacts the repositionable adhesive and the second side of the base sheet to form the photo media. The photo media can be wound into roll form and or converted into the desired size for the photo media. The dry coating thicknesses of the image receptive coating and the repositionable adhesive should be sufficient to provide the desired product attributes, including features such as good print quality (good resolution of the image) and good bonding to a surface. In one embodiment, the dry coating thickness of the image receptive coating is 3 microns or greater and 30 microns or less.

Other methods of making the photo media can be used. For example, the image receptive coating and the repositionable adhesive can be simultaneously applied to the base sheet, followed by a liner attachment step. The repositionable adhesive can be applied to an intermediate surface, such as a transfer roll, and then transferred to the base sheet.

All of the United States Patents and Patent Application Publications cited herein are incorporated by reference in their entirety.

### EXAMPLE

A matte repositionable photo paper can be made as follows.

To a piece of Scholler J80270 matter coated paper, apply two adhesive stripes, each ½ inch (13 mm) wide and separated by 2 inches, on the backside. The adhesive can be a repositionable polyacrylic adhesive of a chemical composition described generally in US Pat. No. 5,824,748. The adhesive can be dried in a conventional convection oven. A silicone-based liner, such as those available from Loparex Inc., Ill., can be laminated to the adhesive coated paper to yield a matte repositionable photo paper. The resulting photo paper can be imaged using a Hewlett Packard Photosmart 385 photo printer. The image thus obtained would have a gloss value at 60° angle of less than 25%. After imaging, the release liner can be removed from the printed photo paper to expose the adhesive stripes and then applied to a painted wall for display.

What is claimed is:

1. A repositionable matte photo media comprising:
an imageable substrate comprising a base sheet having opposing first and second surfaces and an image receptive coating disposed on the first surface of the base sheet; wherein the imageable substrate has a gloss value at 60° of about 25% or less;
a repositionable adhesive disposed on the second surface of the base sheet, wherein the adhesive does not cover the entire second surface; and
a liner disposed on the repositionable adhesive,
wherein the photo media has an adhesion to polyester of less than about 200 gram/inch and a static angle testing adhesion value of greater than about 600 seconds.

2. The photo media of claim 1, wherein the imageable substrate has a gloss value at a 60° angle of about 15% or less.

3. The photo media of claim 1, wherein the imageable substrate has a gloss value at a 60° angle of about 10% or less.

4. The photo media of claim 1, wherein the photo media has an adhesion to polyester of less than about 160 gram/inch and a static angle testing adhesion value of greater than about 1800 seconds.

5. The photo media of claim 1, wherein the base sheet has at least one edge and the repositionable adhesive is in the form of at least one stripe offset from and substantially parallel to the at least one edge.

6. The photo media of claim 1, wherein the repositionable adhesive is a microsphere adhesive.

7. The photo media of claim 6, wherein the repositionable adhesive comprises a polyacrylate derivative.

8. The photo media of claim 1, wherein the image receptive coating is a porous coating comprising oxides or silicates.

9. The photo media of claim 1, wherein the image receptive coating comprises a matting agent and a swellable hydrophilic polymer.

10. The photo media of claim 1, wherein the base sheet is selected from the group consisting of paper, plastic, textile, and non-woven.

11. The photo media of claim 1, wherein the liner is substantially the same size as the base sheet and covers substantially the entire second surface of the base sheet.

12. A method of making a matte repositionable photo media comprising the steps of:
providing a base sheet having opposing first and second surfaces;
coating an image receptive coating on the first surface of the base sheet;
drying the image receptive coating to yield an imageable substrate having a gloss value at 60° of 25% or less;
coating a repositionable adhesive on the second surface of the base sheet, wherein the adhesive does not cover the entire second surface; and
laminating a liner to the second surface of the base sheet so as to cover the repositionable adhesive and covers substantially the entire second surface of the base sheet,
wherein the photo media has an adhesion to polyester of less than about 200 gram/inch and a static angle testing adhesion value of greater than about 600 second.

13. The method of claim 12 wherein the liner comprises a release coating such that upon lamination of the liner to the second surface of the base sheet, the release coating contacts at least the repositionable adhesive.

14. The method of claim 12, wherein the base sheet has at least one edge and the repositionable adhesive is in the form of at least one stripe offset from and parallel to the at least one edge.

15. The method of claim 12 wherein the photo media has an adhesion to polyester less than about 160 gram/inch and a static angle test value of greater than 1800 seconds.

16. The method of claim 12, wherein the base sheet is selected from the group consisting of paper, plastic, textile, and non-woven.

17. The method of claim 12, wherein the paper is calendared.

18. The method of claim 12, wherein the imageable substrate has a gloss value at 60° of 15% or less.

19. The method of claim 12, wherein the imageable substrate has a gloss value at 60° of 10% or less.

20. The method of claim 12, wherein the liner is substantially the same size as the base sheet.
